(19) United States
(12) Patent Application Publication
(10) Pub. No.: US 2020/0233351 A1
(43) Pub. Date: Jul. 23, 2020

(54) IMAGE FORMING APPARATUS

(71) Applicant: Konica Minolta, Inc., Tokyo (JP)

(72) Inventor: Kazuki ODAGIRI, Toyokawa-shi (JP)

(21) Appl. No.: 16/741,223

(22) Filed: Jan. 13, 2020

(30) Foreign Application Priority Data
Jan. 23, 2019 (JP) 2019-009448

(51) Int. Cl. G03G 15/20; B65H 5/02

(52) U.S. Cl. CPC G03G 15/2053; B65H 2701/1916; B65H 5/025

(57) ABSTRACT

An image forming apparatus includes: a belt that is capable of circulating for conveying a recording medium from an upstream side to a downstream side; a fixing pad that presses the belt from inside the belt toward at least a first side; a support member that supports the fixing pad; and a roller. The fixing pad is used in a first mode and a second mode. In the first mode, a first type recording medium passes between the belt and the roller. In the second mode, a second type recording medium passes between the belt and the roller. Assuming that a first point is defined on an upstream side of the fixing pad and a second point is defined on a downstream side, an inclination of a straight line that connects the first point and the second point is different between the first mode and the second mode.

The entire disclosure of Japanese Patent Application No. 2019-009448, filed on Jan. 23, 2019, is incorporated herein by reference in its entirety.

### BACKGROUND

### Technological Field

The present invention relates to an image forming apparatus.

### Description of the Related Art

An image forming apparatus including a fixing device has been known. In recent years, a fixing device adopting a system using a pad has sometimes been employed in terms of energy saving and cost reduction. This system allows the pad having a high degree of freedom in shape. As a result of freely designing pads in consideration of improvement in fixability and the like, some pads may have a complicated shape. When a recording medium like an envelope structured of a plurality of overlapping sheets of paper is conveyed to pass over a pad having such a complicated shape, the conveyance amount is more likely to differ between the sheet of paper on the front side and the sheet of paper on the back side. As a result, the sheets of paper may be creased.

Japanese Laid-Open Patent Publication No. 2017-120398 discloses a technique for reducing the difference in amount of conveyance between the sheet of paper on the front side and the sheet of paper on the back side by reducing the area of contact between a pad and an envelope when the envelop passes over the pad.

### SUMMARY

According to the technique disclosed in Japanese Laid-Open Patent Publication No. 2017-120398, the area of contact between the envelope surface and the pad is reduced, which may lead to unsuccessful conveyance such as slipping. There are two peaks in a pressure distribution in a fixing nip portion when an envelope passes over the fixing nip portion. This pressure distribution does not allow excellent fixability.

Thus, an object of the present invention is to provide an image forming apparatus that is capable of preventing creases that may occur during a fixing operation due to a difference in type of a recording medium.

To achieve at least one of the above-mentioned objects, according to an aspect of the present invention, an image forming apparatus reflecting one aspect of the present invention comprises: a belt that has an endless shape and is capable of circulating for conveying a recording medium from an upstream side to a downstream side; a fixing pad that presses the belt from inside the belt toward at least a first side; a support member that supports the fixing pad from a side opposite to the belt; and a roller. The belt is sandwiched between the roller and the fixing pad. The fixing pad is used in a first mode and a second mode. In the first mode, a first type recording medium passes between the belt and the roller. In the second mode, a second type recording medium passes between the belt and the roller. Assuming that a first point is defined on an upstream side of the fixing pad and a second point is defined on a downstream side of the fixing pad, an inclination of a straight line that connects the first point and the second point is different between the first mode and the second mode.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a conceptual diagram of an image forming apparatus in the first embodiment according to the present invention.

FIG. 2 is a conceptual diagram of a fixing device included in the image forming apparatus in the first embodiment according to the present invention.

FIG. 3 is a partial enlarged view of the fixing device shown in FIG. 2.

FIG. 4 is a first explanatory diagram of a method of attaching a fixing pad to a support member.

FIG. 5 is a second explanatory diagram of the method of attaching a fixing pad to a support member.

FIG. 6 is a cross-sectional view of a fixing pad structure body provided in the fixing device included in the image forming apparatus in the first embodiment according to the present invention.

FIG. 7 is a first explanatory diagram showing the manner in which the fixing pad structure body rotates.

FIG. 8 is a second explanatory diagram showing the manner in which the fixing pad structure body rotates.

FIG. 9 is an explanatory diagram of the relation between a paper discharge angle and a conveyance distance in a fixing nip portion.

FIG. 10 shows a graph of a pressure distribution when performing a fixing operation in the fixing device included in the image forming apparatus in the first embodiment according to the present invention.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

(Configuration)

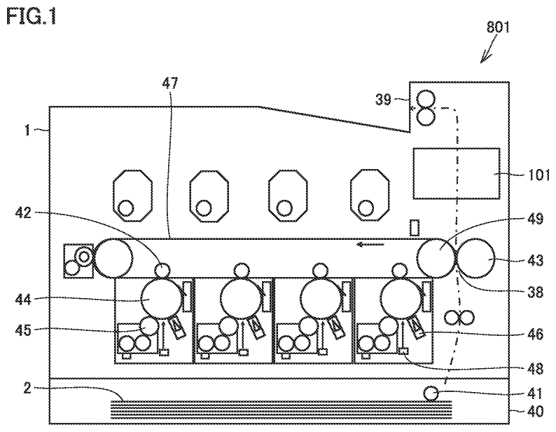

Referring to FIGS. 1 to 8, an image forming apparatus in the first embodiment according to the present invention will be hereinafter described.

FIG. 1 is a conceptual diagram of an image forming apparatus 801 in the present embodiment. Image forming apparatus 801 includes a housing 1 and a cassette 40 that is disposed in a lower portion of housing 1. Housing 1 includes therein a photoconductor 44, a charging unit 46, a transfer belt 47, an image exposure device 48, a developing roller 45, a primary transfer roller 42, a secondary transfer roller 43, a fixing device 101, and the like. One or more recording media 2 are housed in cassette 40. Recording medium 2 may be a sheet of paper, for example, or may be a medium other than a sheet of paper. Transfer belt 47 has an endless shape and is disposed so as to move in a circulating manner.

In image forming apparatus 801, the surface of photoconductor 44 is charged by charging unit 46 so as to uniformly carry a prescribed electric potential. Over this charged area, an image is exposed from image exposure device 48 in accordance with the document image. Thereby, an electrostatic latent image is formed on the surface of photoconductor 44. This electrostatic latent image is developed by developing roller 45 having a development bias applied thereto, and then formed as a visible toner image. A bias for attracting toner is applied to primary transfer roller 42. Thus, the visible toner image on the surface of photoconductor 44 is transferred onto transfer belt 47.

On the one hand, recording media 2 are taken out one by one from cassette 40 by paper feeding roller 41 and conveyed to secondary transfer roller 43. A voltage is applied also to secondary transfer roller 43 as with primary transfer roller 42. Transfer belt 47 is sandwiched between secondary transfer roller 43 and pressing roller 49 so as to constitute a secondary transfer nip portion 38. When recording medium 2 passes over secondary transfer nip portion 38, recording medium 2 and transfer belt 47 are sandwiched and pressed between secondary transfer roller 43 and pressing roller 49. The visible toner image carried by transfer belt 47 is transferred onto recording medium 2 in secondary transfer nip portion 38. Recording medium 2 having the visible toner image carried thereon is fed to fixing device 101. The detailed structure of fixing device 101 will be described later. Fixing device 101 performs heating and pressurization so as to fix the toner onto recording medium 2. Thus, recording medium 2 on which an image has been formed is discharged from an exit 39.

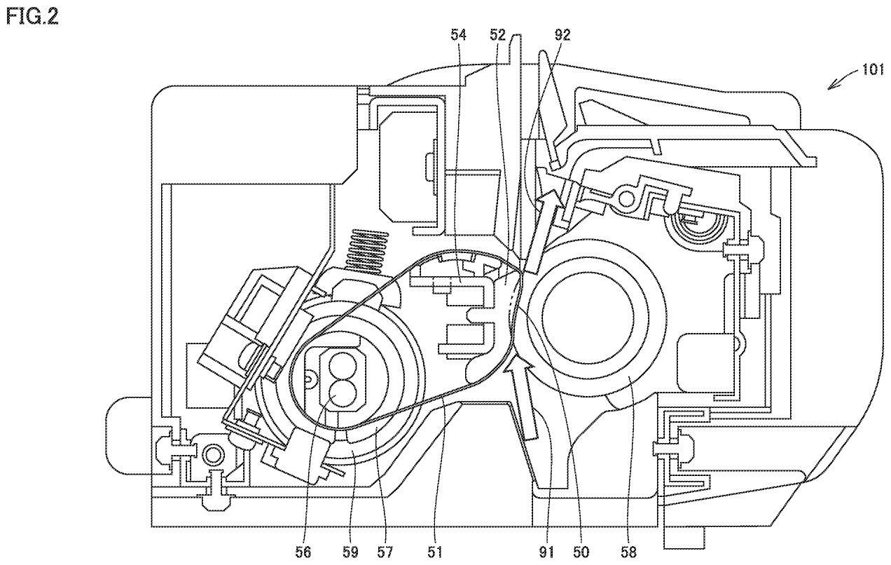

FIG. 2 shows fixing device 101 alone. Fixing device 101 includes a belt 51 having an endless shape, a roller 58 for pressurization, and a fixing pad 52 disposed fixedly on the inside of belt 51. Fixing pad 52 and roller 58 are positioned to sandwich belt 51 therebetween so as to constitute a fixing nip portion 50. Fixing pad 52 defines a path of belt 51. Belt 51 is conveyed along the shape of fixing pad 52.

Fixing pad 52 is supported by a support member 54. A heat source 56 is disposed inside a heating member 57. Belt 51 is tensioned by heating member 57 and fixing pad 52. Roller 58 is rotated by a motor (not shown) at a prescribed rotation speed. Thereby, belt 51 is conveyed.

Fixing pad 52 may be formed of a resin such as polyphenylene sulfide, polyimide, and a liquid crystal polymer, for example. Also, fixing pad 52 may be formed of metal such as aluminum and iron, ceramics, and the like in place of a resin. Fixing pad 52 may include a fixing member made of silicone rubber, fluorine rubber, and the like. Fixing pad 52 may be formed of a combination of two or more components.

Heating member 57 is made of metal such as aluminum or stainless steel (SUS) and formed in an approximately cylindrical shape. Roller 58 has a three-layer structure including a cored bar/an elastic layer/a release layer. It is preferable that the elastic layer is made of a material such as silicone rubber or fluorine rubber having high heat resistance. It is preferable that the cored bar is made of metal such as aluminum or iron. The cored bar may be formed in a pipe shape or may be formed in a solid shape. It is preferable that the release layer is formed of a fluorine tube or has a configuration with releasability by a fluorine-based coating and the like.

Heat source 56 may be a halogen heater. Alternatively, heat source 56 may be a system of applying heat to heating member 57 and/or belt 51 with induction heating (IH). Further alternatively, heating member 57 and/or belt 51 may be formed of a resistance heating element so as to generate heat therefrom.

Recording medium 2 having a toner image transferred thereto is conveyed to fixing nip portion 50 in the state where its surface having the toner image transferred thereto faces heated belt 51. Then, recording medium 2 passes over fixing nip portion 50. Recording medium 2 that passes over fixing nip portion 50 is sandwiched between belt 51 and roller 58 so as to be pressed and heated therebetween. Thereby, the toner image is fixed onto recording medium 2.

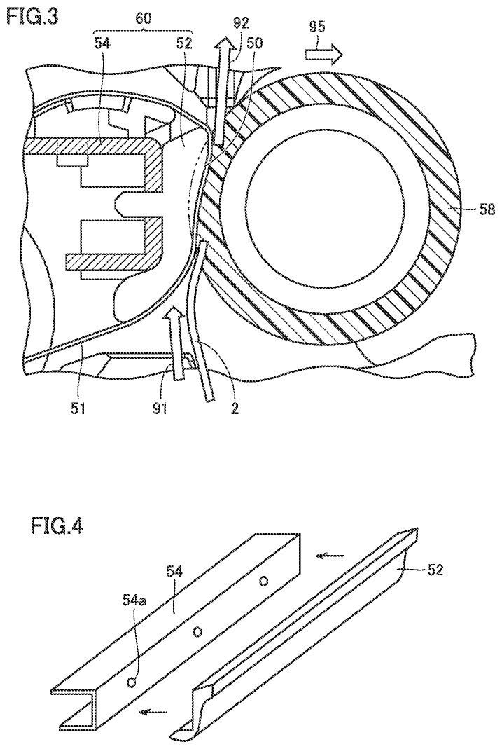

FIG. 3 shows an enlarged view of fixing pad 52 and a region therearound. In this figure, recording medium 2 is conveyed from below to above as indicated by arrows 91 and 92, in which the lower side corresponds to an upstream side while the upper side corresponds to a downstream side.

Recording medium 2 conveyed to fixing nip portion 50 is properly guided to fixing nip portion 50 as indicated by arrow 91. Recording medium 2 having passed over fixing nip portion 50 is discharged from fixing nip portion 50 as indicated by arrow 92.

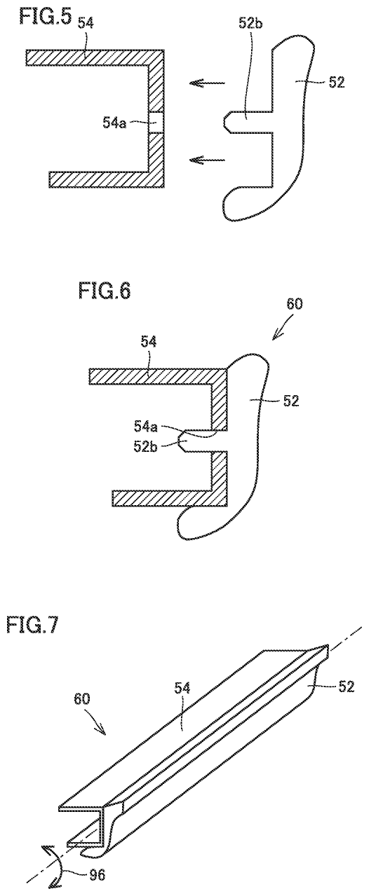

Referring to FIGS. 4 to 6, the process of attaching fixing pad 52 to support member 54 will be hereinafter described. Support member 54 may be formed of a metal sheet. As shown in FIGS. 4 and 5, support member 54 is provided with a hole 54a through which fixing pad 52 is attached to support member 54. As shown in FIG. 5, a pin 52b for attachment to support member 54 is provided on the surface of fixing pad 52 that faces support member 54. By inserting pin 52b into hole 54a, fixing pad 52 can be attached to support member 54. FIG. 6 shows a cross-sectional view of the state where attachment is completed.

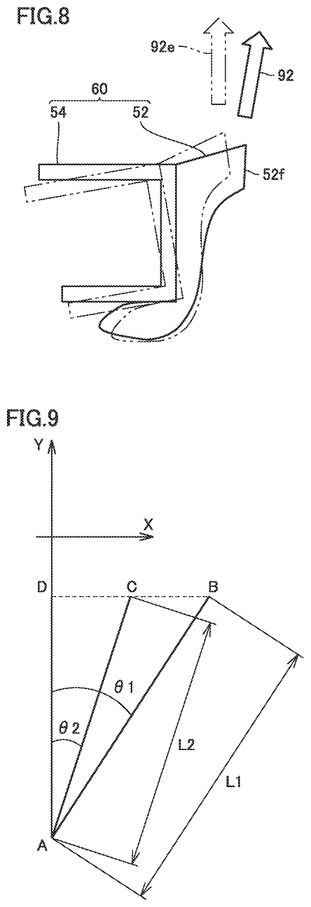

A combination of fixing pad 52 and support member 54 (which will be hereinafter referred to as a “fixing pad structure body”) can be rotated by a prescribed angle as indicated by an arrow 96 in FIG. 7. This rotation can be caused using a motor and the like. In FIG. 7, the central line of this rotation is shown by a dashed-dotted line. This rotation changes the posture of the fixing pad structure body as shown in FIG. 8. In FIG. 8, arrow 92 shows the direction in which recording medium 2 is discharged from fixing nip portion 50. The direction of arrow 92 is set depending on the posture of fixing pad structure body 60. Assuming that recording medium 2 is discharged in the direction indicated by arrow 92 when fixing pad structure body 60 is in the posture shown by a solid line in FIG. 8, recording medium 2 is discharged in the direction indicated by an arrow 92e when fixing pad structure body 60 is in the posture shown by a chain double-dashed line.

It should be noted that fixing pad structure body 60 is not necessarily rotated about the central line that is accurately fixed. Fixing pad structure body 60 may be displaced such that the angle of fixing pad 52 is changed while the central line of the rotation changes. At least the angle of fixing pad 52 may be changed.

The configuration of image forming apparatus 801 in the present embodiment may be described as follows.

Image forming apparatus 801 includes: belt 51 that has an endless shape and is capable of circulating so as to convey recording medium 2 from the upstream side to the downstream side; a fixing pad 52 that presses belt 51 from inside belt 51 at least toward a first side 95; a support member 54 that supports fixing pad 52 from the side opposite to belt 51; and a roller 58. Roller 58 serves to apply pressure. Belt 51 is sandwiched between roller 58 and fixing pad 52. Fixing pad 52 may be used in the first mode and the second mode. In the first mode, a first type recording medium passes between belt 51 and roller 58. In the second mode, a second type recording medium passes between belt 51 and roller 58. Assuming that the first point is defined on the upstream side of fixing pad 52 and the second point is defined on the downstream side of fixing pad 52, the inclination of the straight line that connects the first point and the second point is different between the first mode and the second mode.

As shown in FIG. 8, fixing pad 52 protrudes particularly at its end on the downstream side such that the outline of fixing pad 52 partially has a shape of a nearly straight line. This portion will be hereinafter referred to as a “fixation finishing portion”. Fixing pad 52 has a fixation finishing portion 52f. The first point and the second point are set on the outline of fixation finishing portion 52f when seen in a cross-sectional view of fixing pad 52. Although FIG. 8 does not explicitly show the first point and the second point, the first point may be arbitrarily set at an appropriate position in the vicinity of the end of fixation finishing portion 52f on the upstream side. The second point may be arbitrarily set at an appropriate position in the vicinity of the end of fixation finishing portion 52f on the downstream side.

(Functions and Effects)

In the present embodiment, fixing pad 52 can be used in the first mode in which the first type recording medium passes thereover, and in the second mode in which the second type recording medium passes thereover. The posture of fixing pad 52 differs depending on the mode in which fixing pad 52 is used. Thereby, the fixing operation can be performed while properly preventing occurrence of creases in accordance with the type of recording medium 2. This consequently can prevent any crease that may occur during the fixing operation due to the difference in type of the recording medium.

In the present embodiment, assuming that the first type recording medium is a sheet of paper, the second type recording medium is an envelope, and the posture of fixing pad 52 in the first mode is defined as the first posture, in the second mode, fixing pad 52 is preferably changed from the first posture to the second posture in which the second point is rotated about the first point in the direction away from roller 58. FIG. 8 does not show roller 58, but this roller 58 is located on the right side in the figure and arranged to apply pressure to fixing pad 52. In other words, when the second mode is selected in the case of an envelope, and when fixing pad 52 is changed from the first posture to the second posture for switching into the second mode, it is preferable that the posture of fixing pad 52 is changed such that the downstream side (that is, an upper portion in the figure) of fixing pad 52 is displaced toward the left side in the figure.

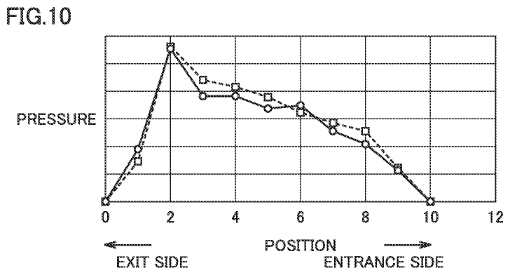

The following is an explanation with reference to FIG. 9 about the reason why it is preferable to change the posture as described above in the case of an envelope. In FIG. 9, the angles are shown in an exaggerated manner so as to allow easy understanding of the explanation. In fixing nip portion 50, the conveyance path of the recording medium does not necessarily have a shape of a straight line, but the conveyance path in fixation finishing portion 52f can be approximated to a straight line. Thus, the conveyance path in fixation finishing portion 52f is shown in a shape approximated to a straight line in this case.

The direction in which support member 54 presses fixing pad 52 is defined as an X-axis while the direction perpendicular to this X-axis and toward the downstream side is defined as a Y-axis. The Y-axis may correspond to the vertical direction, but does not necessarily correspond to the vertical direction. A point in fixation finishing portion 52f on the upstream side of the conveyance path in the recording medium is defined as a point A. The surface of fixation finishing portion 52f inclines. In other words, fixation finishing portion 52f has a shape protruding more largely toward the downstream side. Accordingly, the recording medium discharged after passing over fixing nip portion 50 is not conveyed from point A to a point D in parallel with the Y-axis, but conveyed from point A to a point B, for example. An angle DAB is set at an angle θ1. Like this angle θ1, the angle formed between the Y-axis and the direction in which the recording medium is discharged will be hereinafter referred to as a “paper discharge angle”. The conveyance distance of the recording medium in this case corresponds to a length L1 of a line segment AB. In the case where a recording medium is a plain paper, the recording medium is conveyed at paper discharge angle θ1 in this way and discharged in the desired direction.

In the case where a recording medium is an envelope, the longer conveyance distance is more likely to cause a difference in amount of conveyance between the sheet of paper on the front side and the sheet of paper on the back side. Consequently, creases are more likely to occur. In the case where a recording medium is an envelope, it is preferable to shorten the conveyance distance to the possible extent for preventing creases. The paper discharge angle is changed from θ1 to θ2 that is smaller than θ1, to thereby change the conveyance path from line segment AB to a line segment AC, which results in the conveying distance of a length L2. Since L2<L1, it can be said that creases are less likely to occur when the conveyance path of the recording medium extends along line segment AC. Assuming that line segment AB corresponds to the first mode and line segment AC corresponds to the second mode, the conveyance path is changed between the first mode and the second mode in accordance with the type of the recording medium. Thereby, occurrence of creases can be suppressed as appropriate.

However, the paper discharge angle does not always need to be kept set at θ2. A small paper discharge angle may deteriorate separativeness, for example, in the case of thin sheets of paper. The term “separativeness” used herein means the degree as to how smoothly the recording medium separates from belt 51 after it has passed over the fixing nip portion. With deteriorated separativeness, the sheet of paper having passed over fixing nip portion 50 is not conveyed to be discharged in the originally intended direction after it separates from belt 51, but is more likely to be discharged in an unintended direction behind the timing of separating from belt 51. With reference to FIG. 3, there is an increasing possibility to cause a failure that a sheet of paper that should originally be discharged in the direction indicated by arrow 92 may be discharged more leftward in the figure. Thus, for sheets of paper such as thin paper, the paper discharge angle needs to be large for ensuring separativeness. In the case of an envelope, which has a relatively large basis weight, excellent separativeness is achieved even when the paper discharge angle is relatively small.

Thus, as described above, assuming that the first type recording medium is a sheet of paper, the second type recording medium is an envelope, and the posture of fixing pad 52 in the first mode is defined as the first posture, in the second mode, fixing pad 52 is preferably changed from the first posture to the second posture in which the second point is rotated about the first point in the direction away from roller 58. In other words, it is preferable that the paper discharge angle is set to be smaller in the second mode for an envelope than in the first mode.

For example, it is conceivable that the paper discharge angle is set at 6° or more in the first mode in the case of printing on a commonly used recording medium; and that the paper discharge angle is set at 4° or less in the second mode in the case of printing on an envelope. By changing the paper discharge angle in this way, printing on different types of recording media can be done without any problem.

The section in which roller 58 and belt 51 are in close contact with each other will be hereinafter referred to as fixing nip portion 50. It is preferable to change the posture of fixing pad 52 between the first mode and the second mode such that the peak position in the pressure distribution from the upstream side to the downstream side inside fixing nip portion 50 does not change between the first mode and the second mode. FIG. 10 shows an example of the pressure distribution. The horizontal axis shows the position inside fixing nip portion 50. The numerals of 0 to 12 indicating positions are arbitrarily set for indicating the relative positions inside fixation finishing portion 52f of fixing pad 52. On the horizontal axis, the right side corresponds to the entrance side while the left side corresponds to the exit side. The vertical axis shows acting pressure. In the graph in FIG. 10, a solid line shows the pressure distribution at a paper discharge angle of 6° while a broken line shows the pressure distribution at a paper discharge angle of 4°. The paper discharge angle is changed between 4° and 6°, thereby changing the pressure distribution. In each case, the pressure reaches a peak at a position close to the exit. In other words, the peak position in the pressure distribution does not change between the first mode and the second mode. In order to excellently perform the fixing operation, the highest pressure needs to act at the position close to the exit. As shown in FIG. 10, when the posture of fixing pad 52 is changed between the first mode and the second mode so as to prevent the peak position in the pressure distribution from changing between the first mode and the second mode, the fixing operation can be excellently performed both in the first mode and the second mode.

It should be noted that an envelope is more likely to be creased as the basis weight of the envelope is smaller. The second type recording medium is limited to an envelope having a basis weight equal to or less than a prescribed value. In the case of an envelope having a basis weight greater than the prescribed value, it is preferable that fixing pad 52 is used in the first mode. Thereby, the separativeness can be excellently maintained. An envelope having a basis weight greater than the prescribed value is essentially less likely to be creased when it passes over fixing nip portion 50. Thus, this envelope may be used in the first mode.

Also, it is preferable that the prescribed value is 80 g/m². In other words, it is preferable that the envelope having a basis weight equal to or less than 80 g/m² is used in the second mode, and the envelope having a basis weight greater than 80 g/m² and recording media other than an envelope are used in the first mode.

(Experiment Example)

The present inventor has conducted an experiment under the conditions that the paper discharge angle was changed at four angles of 3°, 4°, 6°, and 9° in fixing device 101 shown in FIG. 2, and, under each of these angle conditions, the fixing temperature was changed at five temperatures of 120° C. to 160° C. Then, the inventor examined how many envelopes were creased among five envelopes in each of combinations of the paper discharge angles and the fixing temperatures. The results are shown in Table 1.

TABLE 1
Number of Creased Envelopes

| | |
|---|---|
| Fixing | Paper Discharge Angle |

| Temperature [° C.] | 3° | 4° | 6° | 9° |
|---|---|---|---|---|
| 120 | 0 | 0 | 5 | 5 |
| 130 | 0 | 0 | 4 | 5 |
| 140 | 0 | 0 | 5 | 5 |
| 150 | 1 | 1 | 5 | 5 |
| 160 | 5 | 5 | 5 | 5 |

At a fixing temperature equal to or greater than 150° C., creases occurred irrespective of the paper discharge angle. At a fixing temperature equal to or less than 140° C., creases occurred at paper discharge angles of 6° and 9°, but no crease occurred at a paper discharge angle of 4° or less. This shows that occurrence of creases in an envelope can be suppressed at a relatively small paper discharge angle. For example, the paper discharge angle may be set at 6° in the first mode while the paper discharge angle may be set at 4° in the second mode.

Among the above-described embodiments, a plurality of embodiments may be employed in an appropriate combination.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a belt that has an endless shape and is capable of circulating for conveying a recording medium from an upstream side to a downstream side;
a fixing pad that presses the belt from inside the belt toward at least a first side;
a support member that supports the fixing pad from a side opposite to the belt; and
a roller, wherein
the belt is sandwiched between the roller and the fixing pad,
the fixing pad is used in a first mode and a second mode,
in the first mode, a first type recording medium passes between the belt and the roller, and
in the second mode, a second type recording medium passes between the belt and the roller, and
assuming that a first point is defined on an upstream side of the fixing pad and a second point is defined on a downstream side of the fixing pad, an inclination of a straight line that connects the first point and the second point is different between the first mode and the second mode.

2. The image forming apparatus according to claim 1, wherein
assuming that a section in which the roller and the belt are in close contact with each other is defined as a fixing nip portion, a posture of the fixing pad is changed between the first mode and the second mode such that a peak position in a pressure distribution from an upstream side to a downstream side inside the fixing nip portion is prevented from changing between the first mode and the second mode.

3. The image forming apparatus according to claim 1, wherein
assuming that
the first type recording medium is a sheet of paper,
the second type recording medium is an envelope, and
a posture of the fixing pad in the first mode is defined as a first posture,
in the second mode, the fixing pad is changed from the first posture to a second posture in which the second point is rotated about the first point in a direction away from the roller.

4. The image forming apparatus according to claim 3, wherein
the second type recording medium is limited to an envelope having a basis weight equal to or less than a prescribed value, and
in a case of an envelope having a basis weight greater than the prescribed value, the fixing pad is used in the first mode.

5. The image forming apparatus according to claim 4, wherein the prescribed value is 80 g/m².
